(19) United States
(12) Patent Application Publication
(10) Pub. No.: US 2007/0081340 A1
(43) Pub. Date: Apr. 12, 2007

(54) LED light source module with high efficiency heat dissipation

(76) Inventors: Huai-Ku Chung, HsinChu (TW); Cheng-Wei Yang, HsinChu (TW); Chien-Hung Lin, HsinChu (TW); Shun-Lih Tu, HsinChu (TW); Hung-Tung Wang, HsinChu (TW)

Correspondence Address: LIN & ASSOCIATES INTELLECTUAL PROPERTY, P.O. BOX 2339, SARATOGA, CA, 95070-0339, US

(21) Appl. No.: 11/246,879

(22) Filed: Oct. 7, 2005

(51) Int. Cl. F21V 29/00

(52) U.S. Cl. 362/294

(57) ABSTRACT

The present invention provides a light source module with high efficiency, super bright LEDs featured with efficient heat dissipation. This invention comprises a printed circuit board installed with an LED array which is composed of multiple emitter LEDs. To achieve efficient effect for heat dissipation, there is more than one hole punctured on the printed circuit board right underneath each emitter LED. The surface of each punctured hole is coated with thermal conductive layer such that the accumulative heat generated by the high power LEDs can be effectively dissipated through the conductive layer.

### FIELD OF THE INVENTION

The present invention generally relates to a light emitting diode (LED) light source module, and more specifically to an efficient heat resistant lighting module, and its application lighting fixtures with high power and super bright LED light source with efficient heat dissipation.

### BACKGROUND OF THE INVENTION

The maturity of the light emitting diode (LED) technology has set fire on the global revolution of the lighting industries. Almost in all aspects of daily lives, such as traffic lights, large screen display, home/office lighting, automobile lighting, commercial art lighting, etc., it is an obvious trend that LEDs will replace all conventional lighting facilities. To efficiently use LEDs for general light source, however, there is one major technical barrier needs to be resolved. Brighter LEDs need higher power and also generate mass heat. Taking the LED arrays used for street lighting as an example, without an efficient heat dissipating facility, the resulting mass heat greatly shortens the life spend of the LED arrays and even affects the overall reliability of the whole lighting unit.

FIG. 1 shows a structural view of a conventional street light using LED arrays 10. The printed circuit board 11 uses a generic FR4 type or the heat dissipating type with thermal conductive metals such as aluminum or copper. When the printed circuit boards are made of FR4, FR5 or other fibril materials with poor heat conductivity, the heat generated from the emitter LEDs 12 cannot be effectively dissipated. It is hard to reduce the overall unit temperature with the heat accumulated on the surface of the printed circuit board 11. Even with the metal dissipation rack 13 on the back side of the printed circuit board, it is still difficult to conduct the heat on the printed circuit board 11 onto the rack of the lighting fixture 14 and be further dissipated into the surrounding atmosphere.

### SUMMARY OF THE INVENTION

The present invention provides an LED light source module featured with high heat dissipation. The high efficient heat dissipation effect is accomplished as follows: one or a few punctured holes are made on the printed circuit board right underneath each emitter LED; the surface of the punctured holes is coated with material with high thermal conductivity; alternatively, the whole punctured holes are filled with materials with high thermal conductivity. This thus facilitates efficient heat dissipation into the surrounding atmosphere.

To achieve the efficient heat resistant effect, the present invention provides an LED light source module, which comprises a printed circuit board with LED array installed. Wherein, right underneath each emitter LED, there is at least one punctured hole, wherein the surface of the punctured holes is coated with a thermal conductive layer.

According to the present invention for an LED light source module, a lighting equipment can be designed as follows: one lighting fixture rack; one LED array installed on one side of a printed circuit board; one printed circuit board on which, right underneath each emitter LED, there is at least one punctured hole; the surface of said hole is coated with thermal conductive material; one light cover which tightly affixes to the lighting fixture rack; wherein the side of the printed circuit board without said LED array also affixes to the inner side of the lighting fixture rack.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a structural view of a conventional street light using LEDs as light source.

FIG. 2 shows a 3-D perspective view of the present invention.

FIG. 3A shows the structure of a cross-sectional view of the present invention.

FIG. 3B shows the structure of a cross-sectional view of a second embodiment according to the present invention.

FIG. 4 shows the structure of a cross-sectional view of a third embodiment according to the present invention.

FIG. 5 shows the structure of a cross-sectional view of a fourth embodiment according to the present invention.

FIG. 6 shows a side elevational cross-sectional view of a first embodiment of an LED street light according to the present invention.

FIG. 7 shows a side elevational cross-sectional view of a second embodiment of an LED street light according to the present invention.

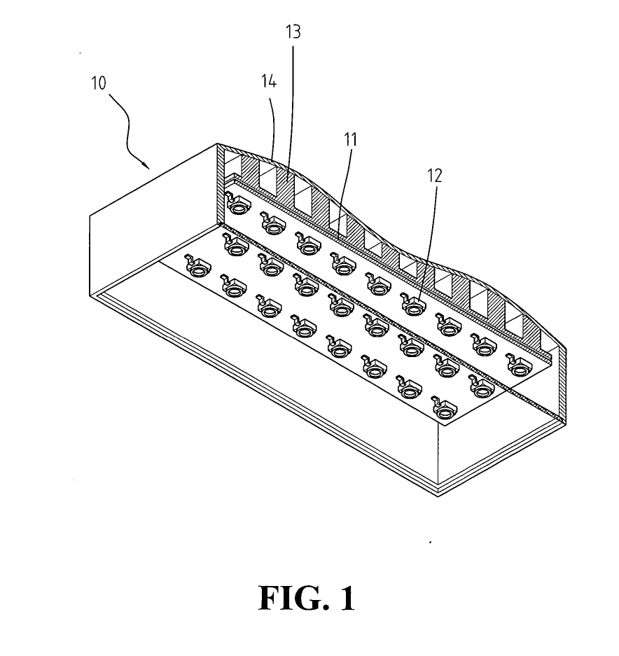

### DETAILED DESCRIPTION OF THE PREFERRED EMBODIMENTS

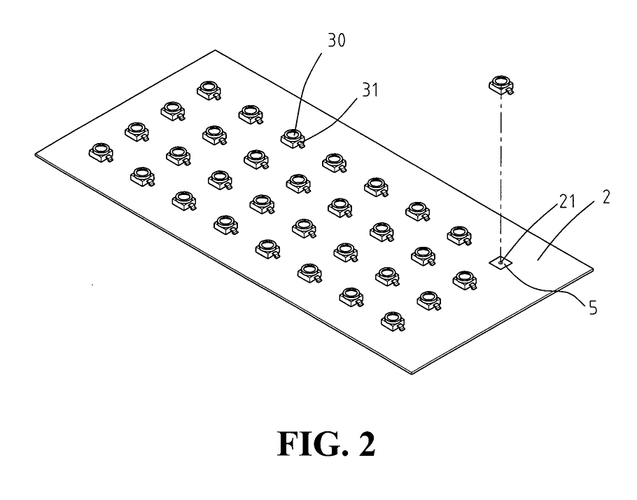

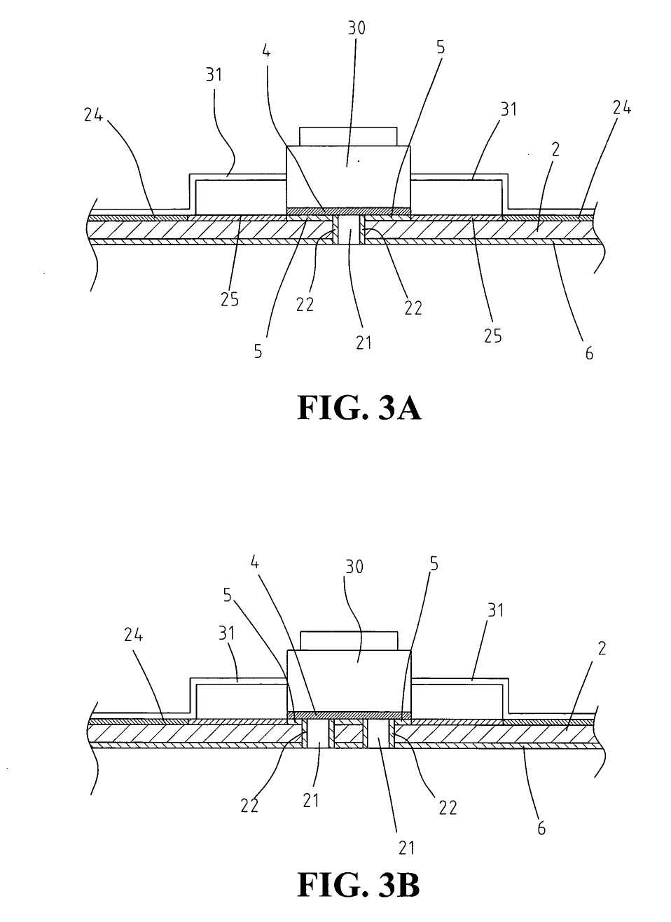

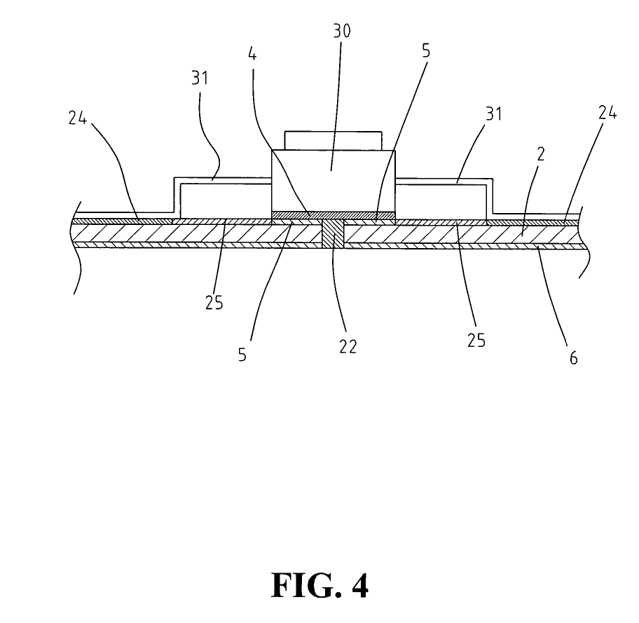

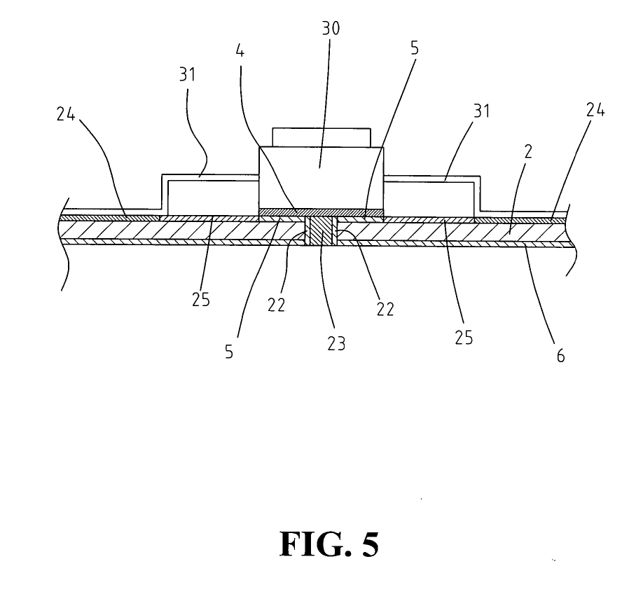

FIG. 2 and FIG. 3A illustrate a 3-D perspective view and the structure of a cross-sectional views of the present invention, respectively. The present invention comprises one printed circuit board 2 and an LED array composing of multiple emitter LEDs 30. Referring to FIG. 3A, on the said printed circuit board 2, where right underneath each emitter LED 30 locates, there is a least one punctured hole 21. (In FIG. 3B, there are two punctured holes 21 on the printed circuit board where right underneath each emitter LED 30). The surface of each punctured hole 21 is coated with thermal conductive layer 22. The thermal conductive layer can be made of material with high thermal conductivity, such as copper, silver, diamond thin film, thermal paste, etc. In the first embodiment of the present invention, the punctured holes 21 are hollow, with only the surface of holes coated with thermal conductive layer 22. Alternatively, the thermal conductive layer can fill up the whole hole 21 (as shown in FIG. 4) to enhance the heat dissipation. Being another variation, as referring to FIG. 5, another thermal conductive material 23 can be used as filler within the thermal conductive layer 22 and form a solid core of heat sink 23. The core of heat sink 23 can be made of materials with high thermal conductivity, such as copper, silver, diamond thin film, thermal paste, etc. depending convenience of fabrication. For instance, the thermal conductive layer 22 can be made of copper, while the core of heat sink can be made of thermal paste.

Each said emitter LED 30 is a high efficiency, super bright LED, which is mounted on the printed circuit board 2 and connects to the electrical conductivity layer of the printed circuit board via a transmission line 31. According to the application diversity, the LED array layout pattern, number of LEDs for the array and the color of the LED light source, etc. can vary to achieve the desired need for color, brightness and chromaticity.

Referring to FIG. 3A, to enhance the heat dissipating effect of each said emitter LED 30, there is a thermal conductive layer 4 formed between each said emitter LED and the printed circuit board 2. The material used for the thermal conductive layer 4 can be thermal paste, thermal plate, or any other media of material and method which can efficiently transmit the heat generated from each said LED 30 onto the printed circuit board 2. To buffer the gap between said emitter LED 30 and the printed circuit board 2 for improved heat dissipation, the first embodiment of the present invention applies a thermal paste coated at the bottom of each said emitter LED 30 as the thermal conductive layer 4.

On the printed circuit board 2, there are metal patches 5 for setting each emitter LED 30. The material of the metal patches 5 can be gold, copper, etc.; the metal patches also connect to the thermal conductive layer 22 on the surface of the punctured hole 21 right underneath each emitter LED 30. Wherein, each metal patch 5 is for heat dissipation, and is different from the electrical metal circuitry 24 on the printed circuit board, which are for the electrical transmission. Metal patches 5 and metal circuitry 24 on the printed circuit board 2 are not connected to each other and are insulated by a soldering layer 25 to prevent short circuitry. Moreover, on the back side of said printed circuit board 2 with no LED array, there is an auxiliary thermal conductive layer 6. The thermal conductive layer 6 can be made of gold, copper, silver, etc., and is connected to the thermal conductive layer 22 on the surface of the punctured hole 21, which is right underneath of each emitter LED. This said auxiliary thermal conductive layer 6 can be designed as a small area which only connects to the thermal conductive layer 22 of the local punctured hole 21; alternatively, the auxiliary thermal conductive layer 6 can also be designed as a global area thermal conducting layer, which connects to the thermal conductive layer 22 of all the punctured holes 21 on the printed circuit board 2. All the metal patches 5, thermal conductive layers 22 and the auxiliary thermal conductive layer 6 can be pre-laid and made available while the printed circuit board 2 is first fabricated. This facilitates the application manufactures with ease of assembly. With the multiple channels of heat dissipation enhancement facilities, the mass heat generated from each emitter LED 30 can be efficiently dissipated on to the printed circuit board 2 through the thermal conductive layer 4, and the metal patch 5. With the thermal conductive layer 22 and the auxiliary thermal conductive layer 6 according to the present invention, the heat from the LED arrays can be further dissipated to the back side of said printed circuit board 2. The overall heat dissipation effect of the whole unit can be further enhanced with complimentary thermal conductive parts on the back side of said printed circuit board 2. Examples are a thermal conducitive fixture or the lighting fixture rack which will be described in the later section.

The present invention can also be enhanced by changing the thickness of the printed circuit board. When the thickness of the printed circuit board is less than 400 μm, (or it is even better with the thickness less than 200 μm), the heat dissipation effect of the whole module can be further improved due to the much shorter and faster thermal transmission with the thin film structure. The thinner version of a printed circuit board also provides the advantage of bendable flexibility for non-planar geometric design for the LED lighting modules, and thus extends the application varieties.

According to the present invention, the punctured holes on the printed circuit board can be made by a standard drilling process. The excimers used for laser drillers can be a gas CO2 RF laser excimer, or an UV solid state Nd:YAG laser excimer. Using Plated-Through-Hole technology for process of de-smear, deformation, micro etching, pre-activating, activating, acceleration, electroless copper (or chemical copper), etc. to achieve a fine-grained thermal conductive metal layer on the surface of the punched holes on the non-conducting printed circuit board. Wherein, the electroless copper is a process to chemically deposit a copper layer on a surface with plating solution containing cupric salt and reducing agents without using electrodes. The plating solution used mainly contains cupric salt (for example cupric sulfate), reducing agents (for example aldehyde acid), chelating agents (for example ethylenediaminetetraacetic acid, EDTA), PH adjuster agent, stabilizing agent and surface-active agent, etc. Wherein, the reducing agent plays the most important role for the self activated reactions. The metal reducing agent is self oxidized to provide the electrodes to reduce the metallic ions in the solution back to metallic atoms and form the metal deposit on a prepared surface. For example, the cupric iron concentration of said deposition solution is 0.035M, the concentration of the reducing agent, aldehyde acid, is 0.06M, and the concentration of the chelating agent, EDTA, is 0.087M. Under the temperature of 60° Celsius, doing the electroless copper deposition with said deposition solution to form the copper layer on the prepared surface of the drilled holes. Then fill the copper coated holes with a thermal paste with high conductivity, such as 2×10⁻³cal/cm sec. ° C. One example of a thermal paste is made of silicone ketone paste with silver oxide particles. Other than copper, silver is also a good candidate for the thermal dissipation layer.

FIG. 4 shows the structure of a cross-sectional view according to the present invention, in which the punctured holes are filled with solid core of heat sinks made of thermal conductive material. This design variation can be manufactured by filling the holes by electrodepositing the thermal conductive copper on the thermal conductive copper layer 22 as shown in FIG. 3A. The plating solution comprises cupric ion source (like cupric sulfate), electrodes (like sulfuric acid, hydrochloric acid), surfactant agent, and a stabilizing agent with selective conductivity control. For example, in the formula of the deposition solution, the concentration of cupric ions is 52 g/l. The concentration of sulfuric acid is 500 g/l; the concentration of the chlorine is 90 ppm. The concentration of the surfactant agent is 160 ppm. Other than copper, the materials used for filling the punctured holes 11 with deposited thermal conductive layer 12 can be also silver, diamond, and thermal pastes, etc.

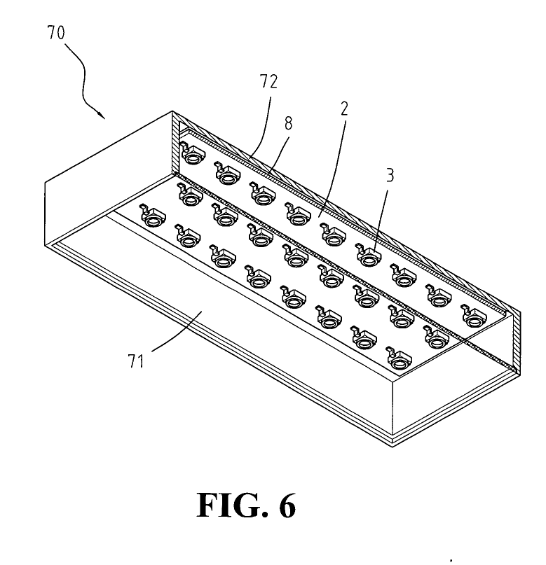

FIG. 6 shows a side-elevational cross-sectional view of an LED street light according to the present invention. The LED street light 70 comprises an LED array 3, which is composed of multiple emitter LEDs arranged as an array, and installed on a printed circuit board 2. With transmission wire, each emitter LED connects to the electro transmission layer of said printed circuit board 2. Depending upon the design of the light cover 71 and the need for uniform illumination, the arrangement of said LED array 3 can vary accordingly. The whole printed circuit board 2 along with the LED array 3 is affixed to the inner side of the lighting fixture rack 72. The back side the printed circuit board 2 with no LED array is tightly attached to the inner side of the lighting fixture rack 72. This makes the lighting fixture rack 72 a direct heat sink. Material with efficient thermal conductivity, metals such as aluminum, copper, etc., are good candidates for the lighting fixture rack. Between the printed circuit board 2 and the lighting fixture rack 72, there is a complimentary thermal cushion layer 8 to ensure perfect contact and enhanced heat dissipation. The thermal cushion layer 8 can be made of thermal paste, thermal plate, or any other media and method which can serve the need for efficiently dissipating the heat from the printed circuit board onto the lighting fixture rack. The resulting LED street light fixture 70 designed with the present invention, with said punctured holes 21 with the thermal conductive layer 22 on the printed circuit board, can efficiently dissipate the heat onto the lighting fixture rack 72 and further into the surrounding atmosphere and greatly improve the overall heat dissipation effect.

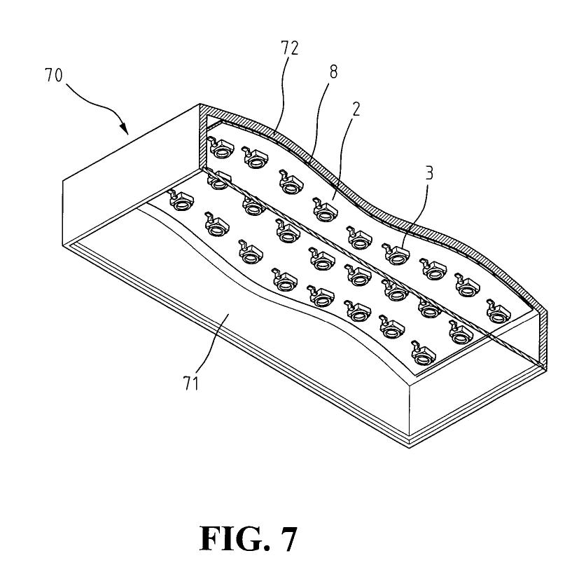

FIG. 7 demonstrates a wavy design of an LED lighting fixture rack 8 with a thinner version of the printed circuit board 6. With the bendable flexibility, the thinner printed circuit board 6 can easily accommodate the wavy shape of the lighting rack 8. With the intimate contact to the surface of the lighting rack 8 retained, the variation of a wavy design of lighting rack 8 still serves as an efficient heat sink for the whole LED lighting fixture.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A light emitting diode (LED) light source module with efficient heat dissipation, comprising:
an LED array composed of multiple high power emitter LEDs; and
a printed circuit board with the said LED array installed;
wherein there is at least one hole made right underneath each said emitter LED, and surface of each hole is coated with a thermal conductive layer.

2. The LED light source module with efficient heat dissipation as claimed in claim 1, wherein said holes on said printed circuit board are punctured holes with thermal conductive layer coated on the surface of the holes.

3. The LED light source module with heat dissipation as claimed in claim 1, wherein said holes on said printed circuit board are punctured holes filled with the same material for said thermal conductive layer.

4. The LED light source module with heat dissipation as claimed in claim 1, wherein the material for said thermal conductive layer is copper.

5. The LED light source module with heat dissipation as claimed in claim 1, wherein the material for said thermal conductive layer is silver.

6. The LED light source module with heat dissipation as claimed in claim 1, wherein the material for said thermal conductive layer is diamond thin film.

7. The LED light source module with heat dissipation as claimed in claim 1, wherein said punctured holes on said printed circuit board are filled with thermal conductive material.

8. The LED light source module with heat dissipation as claimed in claim 1, wherein said thermal conductive material is copper.

9. The LED light source module with heat dissipation as claimed in claim 1, wherein said thermal conducting material is silver.

10. The LED light source module with heat dissipation as claimed in claim 1, wherein said thermal conducting material is thermal paste.

11. The LED light source module with heat dissipation as claimed in claim 1, wherein there is a high thermal conductive layer filled in the gap between said printed circuit board and said emitter LEDs.

12. The LED light source module with heat dissipation as claimed in claim 1, wherein there are multiple metal patches distributed on said printed circuit board, each said metal patch is where an emitter LED locates, and each said metal patch is also connected to the thermal conductive layer on the surface of the punctured hole which is right underneath each emitter LED.

13. The LED light source module with heat dissipation as claimed in claim 1, wherein the side of said printed circuit board with no LED array contains an auxiliary thermal conductive layer, and said auxiliary thermal conductive layer on the board connects to said thermal conductive layer on the surface of all punctured holes on said printed circuit board.

14. The LED light source module with heat dissipation as claimed in claim 1, wherein the thickness of said printed circuit board is less than 400 μm.

15. The LED light source module with heat dissipation as claimed in claim 1, wherein the preferred thickness of said printed circuit board is less than 200 μm.

16. A lighting fixture using the LED light source module featured with heat dissipation, comprising:
a lighting fixture rack;
an LED array as the light source installed on the printed circuit board, and connects to the printed circuit board with transmission wires; and
a printed circuit board, with said LED array installed on it, wherein there is at least one punctured hole, with thermal conductive layer on the surface of the hole, made on the printed circuit board right underneath each emitter LED; and
a light cover, tightly attached to the lighting fixture rack, wherein, the side of the printed circuit board with no LED array is also tightly attached to the inner side of the lighting fixture rack.

17. The lighting fixture using the LED light source module featured with heat dissipation as claimed in claim 16, wherein there is a high thermal conductive layer between the lighting fixture rack and the side of said printed circuit board with no LED array.

18. The lighting fixture using the LED light source module featured with heat dissipation as claimed in claim 16, wherein the material for the lighting fixture rack can be metal or other media with high thermal conductivity.

19. The lighting fixture using the LED light source module featured with heat dissipation as claimed in claim 16, wherein the lighting fixture is an LED light source for street lighting.
